(19) United States
(12) Patent Application Publication
(10) Pub. No.: US 2007/0059844 A1
(43) Pub. Date: Mar. 15, 2007

(54) NON-METAMERIC COLOR MATCHING SYSTEM AND METHOD

(75) Inventors: James Eldon HARPER, Spartanburg, SC (US); David Charles TURNER, Roanoke, VA (US); Kenneth Evan JACOBSON, Alpharetta, GA (US); Brian Stephan WEST, Clinton, TN (US)

Correspondence Address: NOVAK DRUCE & QUIGG, LLP, 1300 EYE STREET NW, SUITE 1000 WEST TOWER, WASHINGTON, DC, 20005, US

(73) Assignee: TECHMER PM, LLC, Rancho Dominguez, CA (US)

(21) Appl. No.: 11/162,485

(22) Filed: Sep. 12, 2005

(51) Int. Cl. C40B 40/04; C40B 30/02; G06Q 99/00

(52) U.S. Cl. 436/518; 524/90; 705/1

(57) ABSTRACT

A pigment library and a method for preparing it are provided, which includes identifying a plurality of thermoplastic polymers and then selecting pigments useful in the plurality of thermoplastic polymers. The pigments are heat stable at the melt temperature of each of the plurality of thermoplastic polymers and are not chemically interactive or reactive with each of the polymers of the plurality of thermoplastic polymer. Further, each of the pigments in combination with each of the polymers of the plurality of thermoplastic polymers possesses the property of being lightfast, injection moldable, and fiber spinnable and also not crocking. A colorant database is then prepared using the pigment library. The colorant database is used with color matching software that predict formulations using the colorant database. The result is the development of formulations that minimize or eliminate metameric color effect under various lighting conditions across multiple polymers and end product types.

### FIELD OF THE INVENTION

The present invention relates to a system and process for matching, formulating and quality controlling the color of a variety products made of different polymers by various product manufacturers to a target sample of polymer product, communicating the ingredient specifications and formulations to the various product manufacturers, and producing a sample or production quantity of products that match in color, and more particularly, that match in color under different lighting conditions.

### BACKGROUND OF THE INVENTION

Realizing the designer's vision related to the total appearance and color harmony of complex parts is challenging, especially where a variety of polymers, physical forms, and textures are used. The most complex example is the development of automobile interiors. Achieving uniform color matches and color harmony among interior trim parts made from differing polymers, paints, and fabrics is arduous when only one lighting source is considered. The additional demands of color harmony in multiple light sources, acceptable UV weatherability, and timeliness of the development process result in unacceptable compromises in product appearance, solar performance, and development time.

A new automotive interior color currently requires thirty-six to forty-eight months from concept to color approval in all commodities. At the conclusion of the development process, various trim parts do not acceptably match under all illumination conditions and some materials do not meet solar testing specifications.

Traditional communication in the color development process between automobile manufacturers and their suppliers is based on physical samples. Based on the designer's color specifications, manufacturers produce color standards in the form of plastic plaques. In some cases, the surfaces of these plaques simulate the various surface textures of the materials concerned, such as grained leather. Using these color standards, the suppliers must create physical samples of the products they are to supply made from a variety of polymers and in various physical forms ranging from extruded molded parts to fibers for carpet and fabrics. Typically, a manufacturing supplier works with a single polymer system in a specialized physical form. The supplier may operate multiple locations and product must be approved from each location. Experience has shown that it is rarely possible to reproduce the color standards exactly. It may be that a supplier of plastic parts cannot produce the precise shade specified using the pigments available. That supplier will therefore make a physical sample of the material to be supplied, which is as close as possible in color to the standard. The same might also apply, for example, to leather and textile suppliers. It is not uncommon for suppliers to provide the automobile manufacturer with a selection of different physical samples. Making these adjusted samples is time-consuming and very expensive.

The automobile manufacturer compares the samples received for the various materials with the color standards. Checks are also made to see whether the colors of the various material samples harmonize with one another in different lighting conditions. It is often impossible to find an acceptable combination using the samples provided: the sample process goes back to the suppliers with instructions for the next attempt. This cycle continues until the colors of all the materials match. Time pressures and costs increase with each new round of samples, and all those involved are placed under increasing stress.

Thus, conventional color development is slow and expensive. It does not address the issues of metamerism. Rather, it only attempts to improve the color communication process to reduce the number of physical sample iterations to achieve the “best” compromise. Instead of speaking in terms of matching in the true sense, the compromise is to achieve “coordination” of the colors of various materials.

In the past, methods used to match color in the polymers industry were subjective and relied on much trial and error. A colorant supplier would have to guess as to which colorant compound or concentrate, out of thousands of previously produced such products, might produce the nearest color match to a target sample, or alternatively, the supplier would create a new colorant product. Based on that guess or new product, a sample was mailed for onsite visual inspection, comparison and evaluation by the customer. If the sample was sufficiently close in color based on subjective evaluation criteria, and therefore a desirable match, the method may end there. Otherwise, the method was repeated either until an appropriate sample was discovered among the multitude of previously produced products, or until modifications were made to an existing or the new formulation that resulted in a sufficient sample match. This unpredictable method resulted in delays that significantly lengthened the time-to-market for a colorant and its final polymer product.

Recent methods of matching colors in the polymer industry allow a colorant supplier to use a spectrophotometer to scan a target sample and generate a spectrum that is specific to that target sample. The generated target spectrum is unique to that sample and acts as a “color fingerprint.” The color fingerprint can be used as a more objective standard than the subjective standard produced by visual inspection or guesswork. This method thus includes the gathering of spectral data from a target sample.

Even more recently, the spectral data of the target sample is used as search criteria for a subsequent search of a database of standard spectral data located in a computer attached to the spectrophotometer. This search allows a close match with the target color to be found and a starting point for reformulation. Starting with the formulation that produces the close match, the formulation is repeatedly reformulated until it becomes an acceptably sufficient color match.

U.S. Pat. No. 6,772,151 discloses a system that has a database that consists of already matched color formulations and their resulting spectra. The system also has software capable of searching a database using the target spectral data as search criteria. When the software searches the database using this search criterion, it returns a match with a data set having standard spectral data that matches the target spectral data within certain tolerances that are relaxed if a sufficiently close match is not initially achieved. Thus, the search mechanism is simply to attempt to match the target to one or more of the “standard” spectra in the database.

However, the systems and methods of the prior art, including that of U.S. Pat. No. 6,772,151, are still deficient when it comes to actually matching products involving different polymers and textures, especially under different lighting conditions. Many consumers have experienced the unsettling effect of having bought an article of clothing or clothes, or even a car that in show room lighting matched in color, but in sunlight did not match in color. For example, one pant leg did not match the other or different parts of the car's interior did not match in color. The automotive industry has struggled with this and still struggles with this phenomenon, called metamerism. Though still desired, the automotive industry has settled for a “coordinated” look, since color matching was beyond their reach on a consistent basis across different lighting conditions.

FIG. 1 depicts the reflectance curves of various polymer products in different forms for automotive interior materials that are all identified by the same color name. The Master Polypropylene (PP) Plaque Target reflectance curve is the overall target for the various products. But, as is clearly visible, there is a wide variation among the reflectance curves. Lighting conditions that accentuate the areas of greater differences in the reflectance curves will cause the various materials to flare in a different visually apparent color causing metamerism. This is why an automobile interior when under showroom lighting looks the same color, but in natural sunlight the various components of the interior can look a different color from each other.

The prior art is deficient in its attempts to truly match color across different polymer systems, textures and forms, plus taking into account and eliminating, or at least minimizing, metamerism.

### SUMMARY OF THE INVENTION

The present invention solves (not manages) the root problems of metamerism and texture by starting at the beginning of the product development process and specifying those pigments that prevent or reduce metamerism in the polymers utilized in making prototypes in textures similar to those that will ultimately be used.

Unlike U.S. Pat. No. 6,772,151 that searches a database of existing “standard” formulations, the present invention uses a primary colorant database and commercially available color matching and prediction software to calculate a best match to the target. The primary colorant database is a spectral database of a series of single-pigment concentrations extruded into shapes and formed into textures similar to the desired part to be matched. The current invention uses commercial software that is calibrated by the primary colorant database to calculate or predict a formulation. This matching can be performed locally with a single computer or over the Internet with two computers.

Metamerism means a phenomenon exhibited by a two or more colors that match under one or more set of conditions, be they real or calculated, but do not match when these conditions are changed.

Illuminant metamerism means a phenomenon exhibited by a pair of colors where two or more spectrally different color samples appear similar in hue under one illuminant but differ in hue under another illuminant.

Accordingly, there is provided a pigment library and a method of making it. There is also provided a colorant palate database and a method of making it, preferably made using the pigment library. The colorant database in turn is used in a system and method of color matching that produces non-metameric matches, thereby eliminating or at least minimizing metameric effects in color matching efforts.

Pigment Library and Method of Making Same

The method for preparing a pigment library includes identifying a plurality of thermoplastic polymers and then selecting pigments useful in the plurality of thermoplastic polymers. The polymers are typically those associated with a particular end use application. For example, in automotive interior trim applications, the plurality of polymers would include polyolefins, polyamides, polyesters, ABS and polyvinyl chloride. The pigments are selected from the group of organic and inorganic pigments.

Each of the pigments possesses the property of being heat stable at the melt temperature of each of the polymers of the plurality of thermoplastic polymers and not chemically interactive or reactive with each of the polymers of the plurality of thermoplastic polymer.

Further, each of the pigments in combination with each of the polymers of the plurality of thermoplastic polymers possesses the property of being lightfast, injection moldable, and fiber spinnable and also not crocking.

Primary Colorant Database and Method of Making Same

The method of preparing a primary colorant database uses the pigment library as a plurality of pigments, wherein the pigments are compatible with a plurality of thermoplastic polymers. A plurality of mixtures of each pigment of the pigment library and a virgin polymer of each of the polymers of the plurality of polymers are prepared at a plurality of pigment concentration desired. A plurality of exhibits are then prepared, wherein each exhibit of the plurality of exhibits corresponds in form to an end product and uses a single pigment at a single concentration in a single virgin polymer. The exhibits can be the same or different and are preferably selected from the group consisting of card wrapped yarn, non-woven fabric, POM sets, knitted socks, plastic plaque smooth surface, plastic plaque textured surfaces, and plastic films.

The reflectance information is then measured for each exhibit of the plurality of exhibits using a spectrophotometer. The reflectance information is stored for each exhibit of the plurality of exhibits.

Non-Metameric Color Selection

The method for color matching uses a target sample having target spectral characteristics to match to a plurality of end products in various forms using a plurality of thermoplastic polymers. The method includes:
(a) measuring the target spectral characteristics of the target sample using a spectrophotometer and generate target spectral data;
(b) for each combination of end product form and corresponding one of the plurality of polymers,
   (1) predicting a sample formulation using the pigment library noted above and the reflectance data of the corresponding to the combination from the primary colorant database as noted above, wherein the sample formulation has a predicted spectral data,
   (2) comparing the predicted spectral data of the sample formulation to the target spectral data to determine if there is a match,
   (3) if there is not a match in step (b)(2), then adjusting the sample formulation until the resulting adjusted sample spectral data matches the target spectral data,
   (4) if there is a match in step (b)(2), then making a trial sample using the sample formulation with the corresponding one of the plurality of polymers in the corresponding end product form,
   (5) determining if there is an acceptable match between the trial sample and the target sample has been achieved as observed under a plurality of lighting conditions,
   (6) if there is not acceptable match in step (b)(5), then measuring the trial spectral characteristics of the trial sample using a spectrophotometer and generating trial spectral data,
   (7) then reformulating the sample formulation based on the differences between the trial spectral data and the target spectral data,
   (8) repeating steps (b)(2) through (b)(7) until an acceptable match is achieved, and
   (9) if an acceptable match is achieved in step (b)(5), then making an exhibit using the sample formulation in the respective end product form;
(c) assembling all of the exhibits together, wherein each of the exhibits has a corresponding one of the plurality of polymers which is in one of the end product forms;
(d) evaluating all of the exhibits using multiple illuminants to verify non-metameric acceptability;
(e) if there is non-metameric acceptability, then approving the sample formulations for use to produce the end products; and
(f) if there is no non-metameric acceptability,
   (1) then measuring the spectral characteristics of the non-acceptable exhibits using a spectrophotometer and generating exhibit spectral data for the non-acceptable exhibits,
   (2) then reformulating the sample formulation based on the differences between the exhibit spectral data and the target spectral data, and
   (3) then repeating starting at step (b)(2) through step (d) for the end product form and polymer corresponding to the non-acceptable exhibits until non-metameric acceptability is achieved for all exhibits.

The steps for predicting, adjusting and reformulating the sample formulation preferably use a formulation software program that utilizes the primary colorant database. However, as known to those skilled in the art, these steps can be performed manually with calculators and graphically.

One way of determining that an acceptable match between the trial sample and the target sample has been achieved is to observe them under a plurality of lighting conditions uses the standard lighting conditions according to SAE J361 (Procedure for Visual Evaluation of Interior and Exterior Automotive Trim). A fixture providing daylight, fluorescent, and horizon lighting conditions provides the multiple illuminants according to this standard.

The color matching method may further include providing a network having a user interface. The target spectral data and information comprising end product form, end product texture, and polymer type are then received through the user interface. The sample formulation is displayed on the network as it is predicted, adjusted and reformulated.

Preferably in addition, the color matching method also includes receiving through the user interface quantity information; implementing software capable of determining a price quote by utilizing the quantity information and the sample formulation; then determining the price quote by utilizing the quantity information and the sample formulation; and displaying on the network the price quote.

There is also provided a system for matching a target sample having spectral characteristics. The system includes:
(a) a first computer at a first location operative to receive and to transmit target spectral data and target non-spectral data;
(b) a second computer at a second location remote from the first location, the second computer being operative to receive the target spectral data and the target non-spectral data from the first computer;
(c) a database including the primary colorant database noted above; and
(d) software residing on the first computer and capable of using the target spectral data and the database to generate a sample formulation having a predicted sample spectral data that matches the target spectral data, wherein the sample formulation also takes into account the target non-spectral data comprising end product form, end product texture, and polymer type. Preferably, the software is further capable of providing a price quote for a product made in accordance with the matching sample formulation.

The database can reside on either the first or second computer.

The system preferably also includes a device operative to sense the target spectral data from a target sample and to input the target spectral data into the first computer. The device is preferably a spectrophotometer.

### BRIEF DESCRIPTION OF THE DRAWINGS

FIG. 1 is a graph showing the reflectance spectra of current (prior art) automotive interior materials that are all identified by the same color name.

FIG. 2 is a graph showing the reflectance spectra of materials with hard plastic surfaces made according to the method of the present invention.

FIG. 3 is a graph showing the reflectance spectra of materials with soft fabric or fiber surfaces made according to the method of the present invention.

FIG. 4 is a block chart diagram showing the steps of one embodiment of the method of present for preparing a primary colorant database.

FIG. 5A is a block chart diagram showing the steps of one embodiment of the method of present for color matching using a local area network (LAN), a primary colorant database and multiple thermoplastic polymers.

FIG. 5B is a block chart diagram showing the steps of one embodiment of the method of present for color matching using the Internet, a primary colorant database and multiple thermoplastic polymers.

FIG. 5C is a block chart diagram showing the steps of one embodiment of the method of present for color matching during a production run for quality control purposes.

FIG. 6 is a color plot of materials produced using the prior art method, which are compared to a target color plaque.

FIG. 7 is a color plot of materials produced using the method of the present invention, which are compared to a target color plaque.

FIG. 8 is a block chart diagram depicting the primary pigment selection criteria for pigments differentiated by suitability in specific polymer systems.

FIG. 9 is a block chart diagram depicting the primary pigment selection criteria for pigments differentiated by suitability to specific process conditions.

FIG. 10 is block chart diagram depicting the secondary pigment selection criteria for pigments differentiated by inherent physical properties.

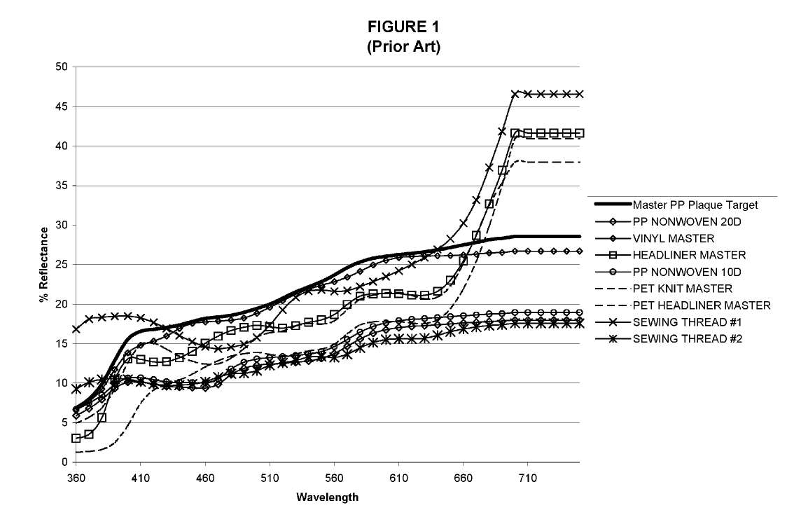

### DETAILED DESCRIPTION OF THE INVENTION

In the automotive arena, a variety of thermoplastic polymers are used for various interior and exterior parts and components. These include, but are not limited to,: polyolefins, such as polypropylene (PP) and polyethylene (PE); polyesters, such polyethylene terephthalate (PET) and polybutylene terephthalate (PBT); nylon, such as nylon 6 and nylon 6,6; acrylonitrile butadiene styrene (ABS); and polyvinyl chloride (PVC). In additional to the variety of polymers, the matching must deal with multiple textures, such as fibers, carpets and plastics.

In order to decrease development time and cost and address metameric issues within a polymer or among a plurality of polymers, the automotive color matching process of the present invention uses a colorant database, primaries with textures similar to the end-product, and computer matching early in the development cycle to match multiple polymer systems to identify a universal formulation that gives non-metameric matches and predictable UV performance. The root problem of the prior art is the lack of specification of the raw materials to help producers of such parts and components. Many suppliers work in a vacuum because they have no knowledge about the development of others. Color development at each supplier is totally unrestricted with regard to the selection of pigments and interpretation of color. One such example is with automotive interior trim producers who are focused on a single interior commodity. As a result, they experience additional color development restarts due to metamerism with other vendor's approved materials of the “same” color. Further, this individual approach brings to bear the different philosophies and development approaches that each supplier has relative to metamerism, UV performance, costs vs. quality, and solar test risk, among other things. The different suppliers also have different levels of expertise, for example, relative to color and polymer chemistry. Thus, they may use different chemistries and color palettes. Poor choices of pigments, the selection of pigments that do not work in multiple polymer systems, and the difficult management process all combine to create commodities that are metameric and do not meet solar testing requirements.

The failure to specify chemistry and components results in metamerism, variable solar testing performance, solar testing failures discovered late in development cycle, built-in color variation, cost duplication, excessive complexity, reliance on appearance specification only, product realization time issues, and limitation to local (U.S.) supply.

One main area involves colorant selection suitable for the polymers and the end use. By specifying raw materials that are (1) available globally, (2) lightfast for automotive requirements, and (3) suitable for multiple polymeric systems, approvals can be obtained faster. This would minimize or eliminate metameric problems and provide predictable UV performance. Process variation and “path variation” would also be reduced. The formulation time based on the number of submissions prior to receiving approval is reduced. Using prior art methods, the “concept to product realization” time is from fifteen to eighteen months. The present invention would reduce that time down to three to six months. The quality of product submissions for approval in terms of shade, hue, texture, metameric differences, and solar test risk are improved.

Thus, a system of color development and control, applicable to individual or multiple extruded polymer systems, is provided to: (a) reduce metamerism and increase color harmony, (b) predict solar performance, (c) speed development, and (d) reduce product color variation.

From the perspective of product development, the system creates non-metameric color matches in one or more polymers in a variety of extruded applications, including but not limited to thick-section molded plastics, films, extruded fibers for non-wovens, tufted carpets, knitted fabrics, and woven fabrics. By specifying raw materials such as colorants that are available on a global basis, the system controls the repeatability of extruded product color in a manufacturing environment where color variation of raw materials may exist. By integrating a standard colorant concentration database available electronically either locally or globally via the Internet, the system provides increased computer prediction accuracy.

According to one embodiment of the present invention, there is provided a four component color system incorporating the following:

1. The Definition of a Colorant Palette

The definition of a specific palette or library of commercially available colorants, such as, colorants available from Techmer PM, whose chemistry and performance meet the requirements of a specific end use, e.g., thermoplastic polymer resin compatibility, resistance to solar fading, etc. and that is universally available to any customer. This standardization is an important feature of the present invention, which also minimizes supply chain effects. Concurrent color development with different polymer systems is now achieved by using substantially the same pigments in every polymer system.

2. The Establishment of Primary Colorant Calibration Tool.

For each colorant or pigment in the defined palette, a database is developed that relates the reflectance spectra of a known pigment concentration in a polymer system and physical form. For each pigment, reflectance spectra are obtained for multiple concentrations in the typical range of use. These are measured and stored electronically and then used with commercially available color matching software systems. The physical form used is similar to the end-use. Thus, for each colorant of the palette, exhibits are produced that represent the colorant extruded at multiple, known concentrations in physical forms that represent the extruded final product application, e.g. non-woven carpet, tufted carpet, staple fiber, filament yarn, thick-section molded plastics, films, etc. The color matching software uses the reflectance/concentration data to predict formulations in the color matching and color control process.

The colorant concentrations used for the calibration tool are selected to be in the range of typical concentration usage in the final product application.

The exhibit for each colorant at each concentration is characterized by use of a spectrophotometer to measure the relative intensity of exhibit's reflectance as a function of visible-light wavelength. The compilation of these is referred to as a reflectance curve or reflectance spectrum.

The reflectance curve for each exhibit is stored in a colorant calibration database and is used with commercially available color-matching and color correction software.

The primary colorant calibration tool can be provided electronically to customers with compatible software, or it can be provided physically in the form of the individual exhibits extruded at various concentrations.

As part of the efforts associated with the development of such a calibration tool according to the present invention, the following is a list of nine pigments or colorants using a color index as an identifier that can be used according to the present invention. Techmer PM offers these pigments in various polymer resin carriers for enhanced disperability is corresponding polymers. These nine colorants cover the color space and satisfy the primary and secondary criteria of the present invention:

| | |
|---|---|
| PR 101 | Red Iron Oxide YS |
| PR101 | Red Iron Oxide BS |
| PR 149 | Perylene Red |
| PY 119 | Zinc Ferrite |
| PY 110 | Yellow 2RLTS |
| PB 60 | Indathrone Blue |
| PG 7 | Phthalo Green BS |
| PBK 7 | Carbon Black 660 |
| PW 6 | White R-960 |

Additional colorants or pigments that satisfy the requirements of the present invention are also available from Techmer PM. The color palate or library uses at least three concentrations, preferably at least 7 concentrations, of each of the pigments in the various polymers, which are then produced in non-woven and staple fiber form or as a solid plastic plaque.

3. The Application of Computer-Based Color-Matching Software to Create Standards.

The target's reflectance curve is measured. Commercial software compares the reflectance curve of a material to be color-matched (“target”) with the primary colorant database. The software predicts colorant combinations and concentrations of colorants to be used to formulate a new color that will approximate the reflectance curve of the target. For each polymer system and physical form samples are prepared, measured and viewed in comparison to the target. The pigments used in each sample may vary in concentration depending on the physical form and polymer system, but all utilize substantially the same pigments. Small amounts of differing pigments may be used as minor tints in the system to offset hue differences due to light scattering differences between different physical forms or due to natural polymer color. The final evaluation is an acceptable non-metameric performance when viewing all of the samples in various lighting systems.

In a formulation development process, a sample is produced and its reflectance curve is compared to the target reflectance curve. If necessary to achieve an acceptable match, the software predicts a modified formula to achieve an improved color match. The process is iterated until the desired sample color is achieved. The resultant match defines the formulation and the product standard.

A “working standard” is created in a physical form that can be duplicated in the production environment, e.g. staple fiber, filament, non-woven, tufted carpet. In other words, samples for color evaluation are prepared in a format that approximately simulates the end-use products in terms of the appearance, surface, and texture. That is, injection molded plaques are matched to molded plaques, tufted carpets to tufted carpets, etc. These are used to evaluate and color control future production.

4. The Application of Computer-Based Color-Correction Software.

In a production environment, a specimen is collected and processed into a form suitable for measurement. The specimen's reflectance curve is compared to the standard's reflectance curve and if outside of predetermined limits, the software predicts a corrected formulation. The corrected formulation is applied to the product. With color-correcting software, the colorant calibration tool is used to control future production color.

The system of the present invention provides color matching and harmony with predictable UV performance at early stages of development which increases the speed of product development and acceptance with improved product repeatability and thereby quality control between various polymers and end products.

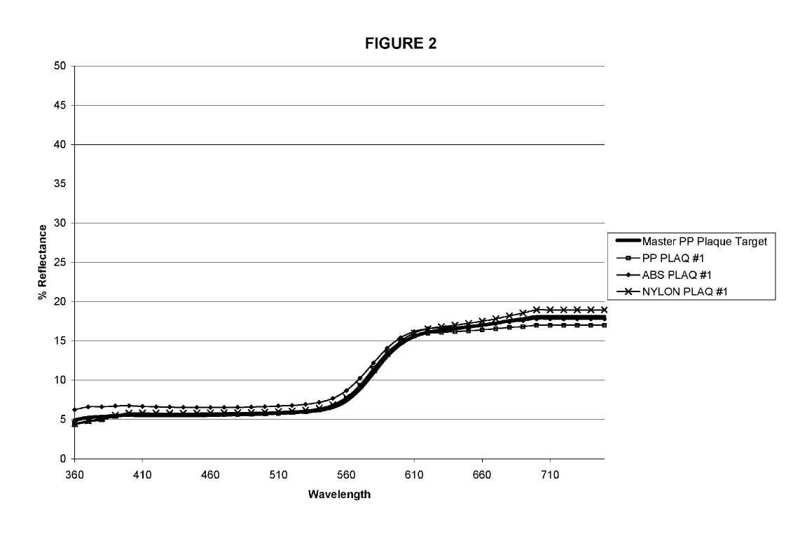

FIG. 2 is a graph showing the reflectance spectra of materials having hard plastic surfaces made according to the method of the present invention. The spectra are of the master polypropylene plaque target and plaques made according to the method of the present invention using polypropylene (PP), acrylonitrile butadiene styrene (ABS) and nylon 6 (Nylon).

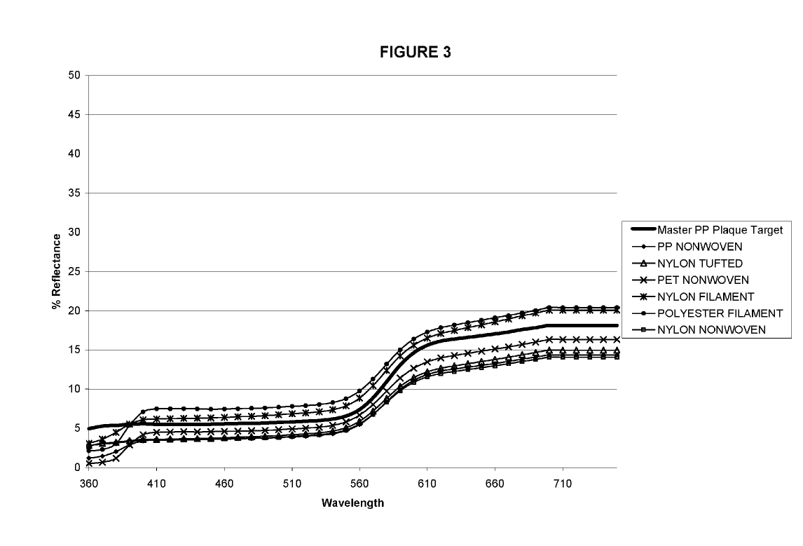

FIG. 3 is a graph showing the reflectance spectra of materials with soft fabric or fiber surfaces made according to the method of the present invention. The spectra are of the master polypropylene plaque target (hard surface) and (a) non-wovens made according to the method of the present invention using polypropylene (PP), polyethylene terephthalate (PET) and nylon 6 (Nylon), (b) filaments made according to the method of the present invention using nylon 6 (Nylon) and polyethylene terephthalate (Polyester), and (c) tufted nylon 6 (Nylon) made according to the method of the present invention.

The spectra shown in FIGS. 2 and 3 match more closely that of the master PP plaque and have a very similar shape along their entire reflectance spectra. This results in minimizing, or eliminating, metamerism since regardless of lighting source, the various materials will flare in a similar manner maintaining a color match across all these materials.

The pigments that were used for the materials shown in FIGS. 2 and 3 to match the OEM-supplied target (plaque) were:

TABLE 1A
(FIG. 2)
Hard Surfaces

| Color Index | Polypropylene | Nylon | ABS |
|---|---|---|---|
| Pigment White 6 | TPM1375 | TPM1843E4 | NA |
| Pigment Black 7 | PPM9060 | BK2205E | BK2205E |
| Pigment Red 101 | PPM41319 | BMB R-11 | BMB R-11 |
| Pigment Red 101 | PPM41354 | BMB R-5 | BMB R-5 |

TABLE 1B
(FIG. 3)
Soft Surfaces

| Color Index | Polypropylene | Nylon | Polyester |
|---|---|---|---|
| Pigment White 6 | TPM1375 | PNM11304 | PTM11617 |
| Pigment Black 7 | PPM9060 | PNM9146 | PTM9200 |
| Pigment Red 101 | PPM41319 | PNM41322 | PTM41619 |
| Pigment Red 101 | PPM41354 | PNM41196 | PTM41643 |

These were chosen based on their compatibility with the polymer (no adverse chemistry) and for their lightfastness. They were also able to produce a good spectral match to the OEM-supplied target.

In Tables 1A and 1B, there are different Techmer PM part numbers for the same pigment with different carrier resins. Sometimes there can also be different Techmer PM part numbers for differing concentrations of the same pigment in the same carrier resin. Further note that the carrier resin can be the same or different than the bulk polymer, e.g., a nylon pigment carrier resin would typically be used for nylon fiber. However, using the same pigment, it is possible for a polyethylene pigment carrier to be used for nylon or polypropylene (bulk polymer).

Some pigments would not generally be suitable for automotive end uses, e.g. Pigment Red 214 due to lightfastness considerations. Other pigments are lightfast in some polymers but not others, e.g. Pigment Violet 19 is suitable in polypropylene, but not in condensation polymers like nylon and polyester. Pigment Blue 15 is suitable for PVC, but not for other polymers due to its heat stability limitation to 200° C. In summary, each pigment must be considered in relation to every polymer system being used. The criteria for suitability can vary depending on the final application and can include, for example, colorfastness, temperature stability, chemical reactivity and toxicity among others.

Various standards are use to determine acceptable performance regarding these criteria. For example, some of these are specific to GM, Ford and Chrysler. Some of these standards define the testing conditions like SAE J1885 and SAE J1960 for artificial weathering. There are others for Arizona desert testing, such as GM 9538P and Ford DVM0020.

Then, there are specific standards that define the acceptability of the materials which are all specific to the OEM. GM2794M calls out the requirements for carpets, for instance. There are many, many methods called out for each part and textile.

Other criteria include those that one might not think of initially, for example, fogging, which is covered by SAE J1756 as the testing standard with different OEMs having different acceptability requirements. Another fiber testing requirement is for “crocking” (AATCC 8) that measures the rub-off of color.

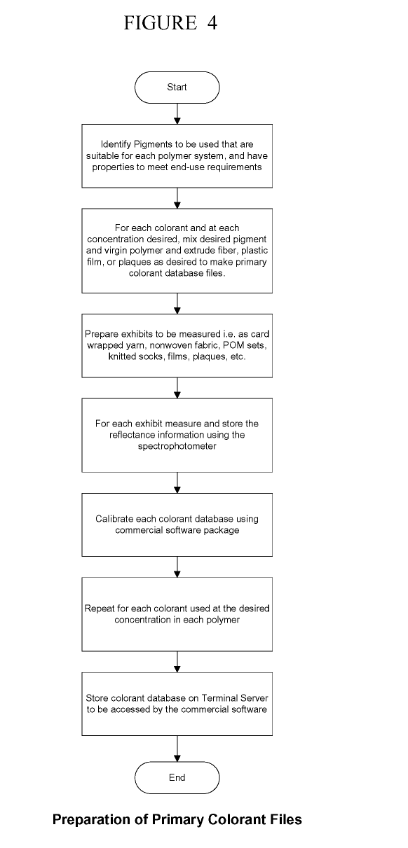

Referring now to FIG. 4, the method of preparing a primary colorant database is shown in block chart diagram format with the steps depicted addressed below:
1. Start
2. Identify pigments to be used that are suitable for each polymer system, and have the properties to meet end-use requirements.
3. For each colorant and at each concentration desired, mix the desired pigment and virgin polymer and extrude fiber as desired to make primary colorant database files.
4. Prepare exhibits to be measured, i.e., as card wrapped yarn, non-woven fabric, POM sets, knitted socks, etc.
5. For each exhibit, measure and store the reflectance information using a spectrophotometer.
6. Calibrate each colorant database using commercial software package.
7. Repeat for each colorant used at the same desired concentrations in each polymer.
8. Store colorant database on a Terminal Server to be accessed by commercial software.
9. End

For the colorant database developed using the foregoing pigments, the following concentrations were used:
% raw pigment in fiber by weight:
0.0001%, 0.001%, 0.005%, 0.010%, 0.050%, 0.100%, and 1.00%.

Other percentages or levels can be used as desired. For example, it may be preferable to eliminate the 0.0001% level and replace it with a 0.5% level.

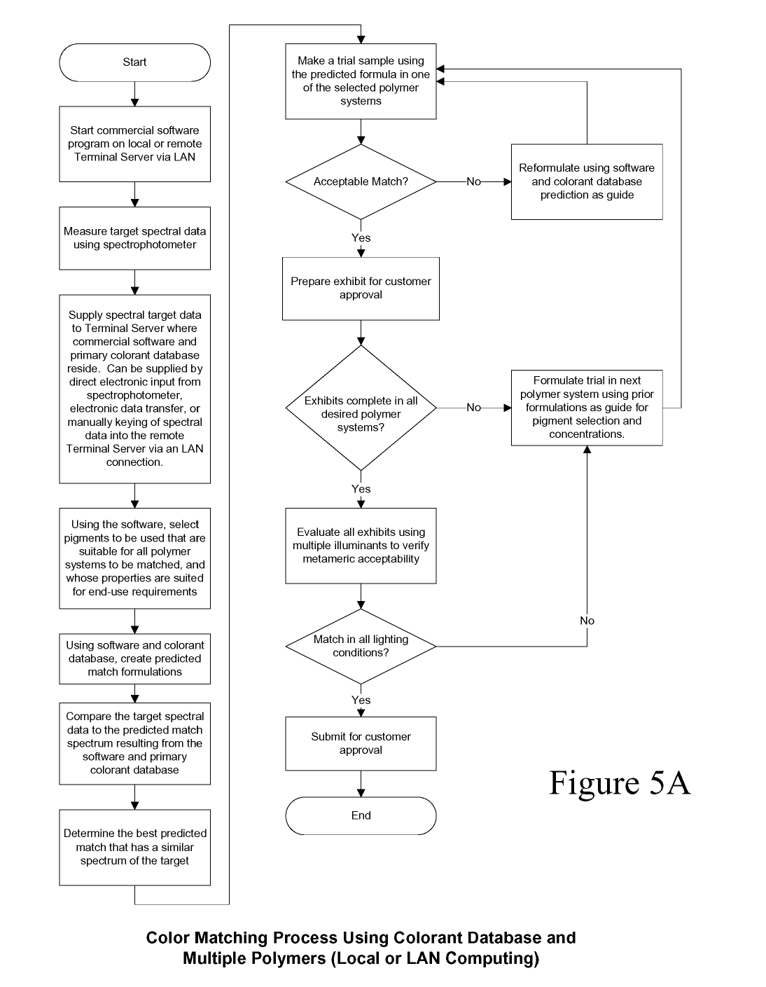

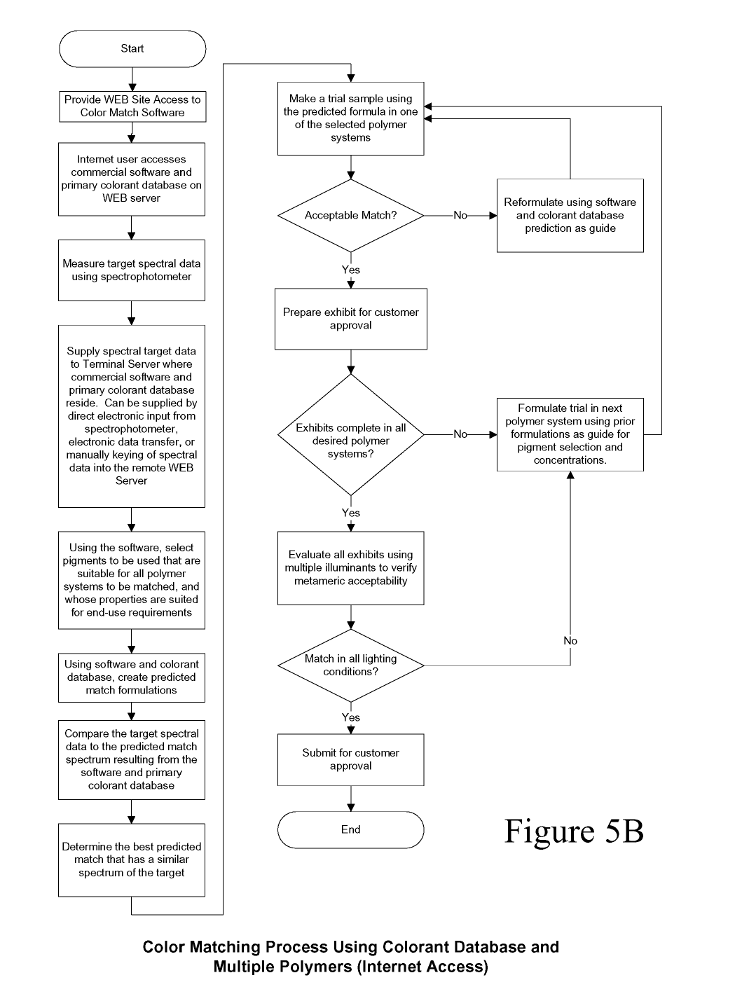

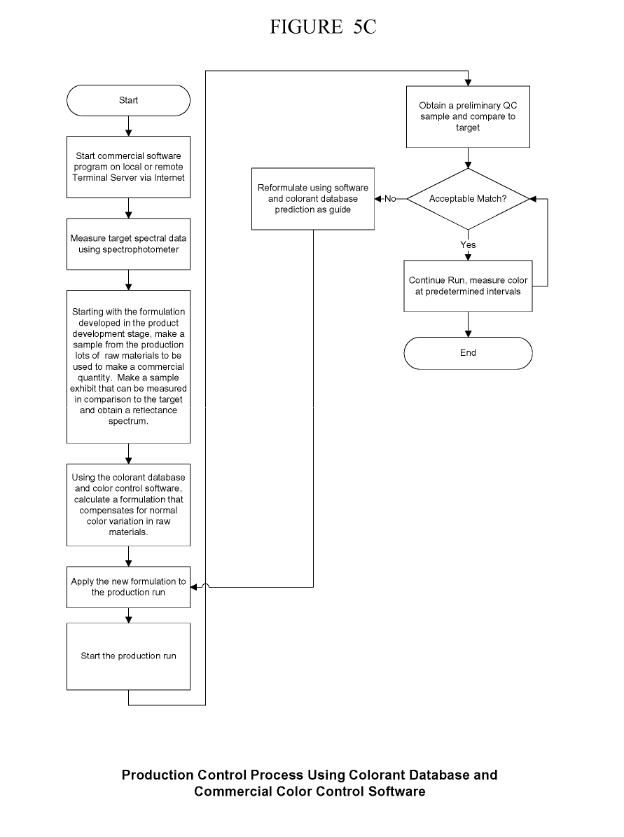

Referring now to FIG. 5A, there is shown a block chart diagram showing the steps of one embodiment of the method of present invention for color matching using a local area network (LAN), a primary colorant database and multiple thermoplastic polymers. The steps are addressed below:
1. Start
2. Start the commercial color match software program on local or remote Terminal Server via LAN.
3. Measure target spectral data using spectrophotometer.
4. Supply spectral target data to Terminal Sever where commercial software and primary colorant database reside. Can be supplied by direct electronic input from spectrophotometer, electronic data transfer, or manually keying of spectral data into the remote Terminal Server via a LAN connection.
5. Using the software, select pigments to be used that are suitable for all polymer systems to be matched, and whose properties are suited for end-use requirements.
6. Using software and colorant database create the predicted match formulations.
7. Compare the target spectral data to the predicted match spectrum resulting from the software and primary colorant database.
8. Determine the best-predicted match that has a spectrum similar to the spectrum of the target.
9. Make a trial sample using the predicted formula in one of the selected polymer systems.
10. Determine if an acceptable match has been achieved. Visual acceptability is the appearance judged by the development engineer as that which will meet approval by an OEM appearance engineer as observed under standard lighting conditions defined by SAE J361 (Procedure for Visual Evaluation of Interior and Exterior Automotive Trim).
11. If not an acceptable match, reformulate using the software and colorant database prediction as a guide. The non-acceptable trial is measured by the spectrophotometer and a new formulation is predicted by the commercial color-matching software or is based on the experience of the development engineer.
12. Repeat steps 9 through 11, until an acceptable match is achieved.
13. [From step 10] If yes, then prepare exhibit for customer approval.
14. Determine whether exhibits complete in all desired polymer systems.
15. If no, formulate trial in next polymer system using prior formulations as guide for pigment selection and concentrations.
16. Then go to Step 9.
17. If yes, then evaluate all exhibits using multiple illuminants to verify non-metameric acceptability. The method for light room review of automotive materials is defined by SAE J361 entitled Procedure for Visual Evaluation of Interior and Exterior Automotive Trim. A suitable fixture providing daylight, fluorescent, and horizon lighting conditions is necessary for this evaluation.
18. Do exhibits match in all lighting conditions?
19. If no, then go to Step 15.
20. If yes, then submit to customer for approval.
21. End.

Referring now to FIG. 5B, there is shown a block chart diagram showing the steps of one embodiment of the method of present invention for color matching using the Internet, a primary colorant database and multiple thermoplastic polymers. The steps are addressed below:
1. Start
2. Provide WEB site access to commercial color match software program.
3. Internet user accesses the color match software and primary colorant database on WEB server.
4. Measure target spectral data using spectrophotometer.
5. Supply spectral target data to Terminal Sever where commercial software and primary colorant database reside. Can be supplied by direct electronic input from spectrophotometer, electronic data transfer, or manually keying of spectral data into the remote WEB Server via an Internet connection.
6. Using the software, select pigments to be used that are suitable for all polymer systems to be matched, and whose properties are suited for end-use requirements.
7. Using software and colorant database create the predicted match formulations.
8. Compare the target spectral data to the predicted match spectrum resulting from the software and primary colorant database.
9. Determine the best-predicted match that has a spectrum similar to the spectrum of the target.
10. Make a trial sample using the predicted formula in one of the selected polymer systems.
11. Determine if an acceptable match has been achieved. Visual acceptability is the appearance judged by the development engineer as that which will meet approval by an OEM appearance engineer as observed under standard lighting conditions defined by SAE J361 (Procedure for Visual Evaluation of Interior and Exterior Automotive Trim).
12. If not an acceptable match, reformulate using the software and colorant database prediction as a guide. The non-acceptable trial is measured by the spectrophotometer and a new formulation is predicted by the commercial color-matching software or is based on the experience of the development engineer.
13. Repeat steps 10 through 12, until an acceptable match is achieved.
14. [From step 11] If yes, then prepare exhibit for customer approval.
15. Determine whether exhibits complete in all desired polymer systems?
16. If no, formulate trial in next polymer system using prior formulations as guide for pigment selection and concentrations.
17. Then go to Step 10.
18. If yes, then evaluate all exhibits using multiple illuminants to verify non-metameric acceptability. The method for light room review of automotive materials is defined by SAE J361 entitled Procedure for Visual Evaluation of Interior and Exterior Automotive Trim. A suitable fixture providing daylight, fluorescent, and horizon lighting conditions is necessary for this evaluation.
19. Do exhibits match in all lighting conditions?
20. If no, then go to Step 16.
21. If yes, then submit to customer for approval.
22. End.

It typically takes about 2 to about 4 iterations to make the typical match using the present invention.

Examples of suitable commercially available software programs include, but are not limited to, Shelyn SLI-Form® Colorant Formulation Software for Textiles available from GretaMacbeth, Greensboro, N.C.; Match-Pigment™ available from Datacolor, Lawrenceville, N.J.; Ciba® Colibri™ Color Matching Software available from Ciba Specialty Chemicals, Tarrytown, N.Y.; and Color iMatch available GretaMacbeth LLC, New Windsor, N.Y.

FIG. 5C is a block chart diagram showing the steps of one embodiment of the method of present for color matching for production control process using a primary colorant database and a color control software.
1. Start
2. Start the commercial color match software program on local or remote Terminal Server via Internet.
3. Measure target spectral data using spectrophotometer.
4. Starting with the formulation developed in the product development stage, make a sample from the production lots of raw materials to be used to make a commercial quantity. Make a sample exhibit that can be measured in comparison to the target and obtain a reflectance spectrum.
5. Using the software and colorant database, calculate a formulation that compensates for normal color variation in raw materials.
6. Apply the new formulation to the production run.
7. Start the production run.
8. Obtain a preliminary quality control (QC) sample and to the target spectral data.
9. Determine if the is an acceptable match between the QC sample and to the target.
10. If not acceptable, then reformulate using the software and the colorant data base prediction as a guide.
11. The go to step 6.
12. If there is an acceptable match from step 9, then continue the production run, measuring color at predetermined intervals and compare to target reperforming step 9 each time.
13. End.

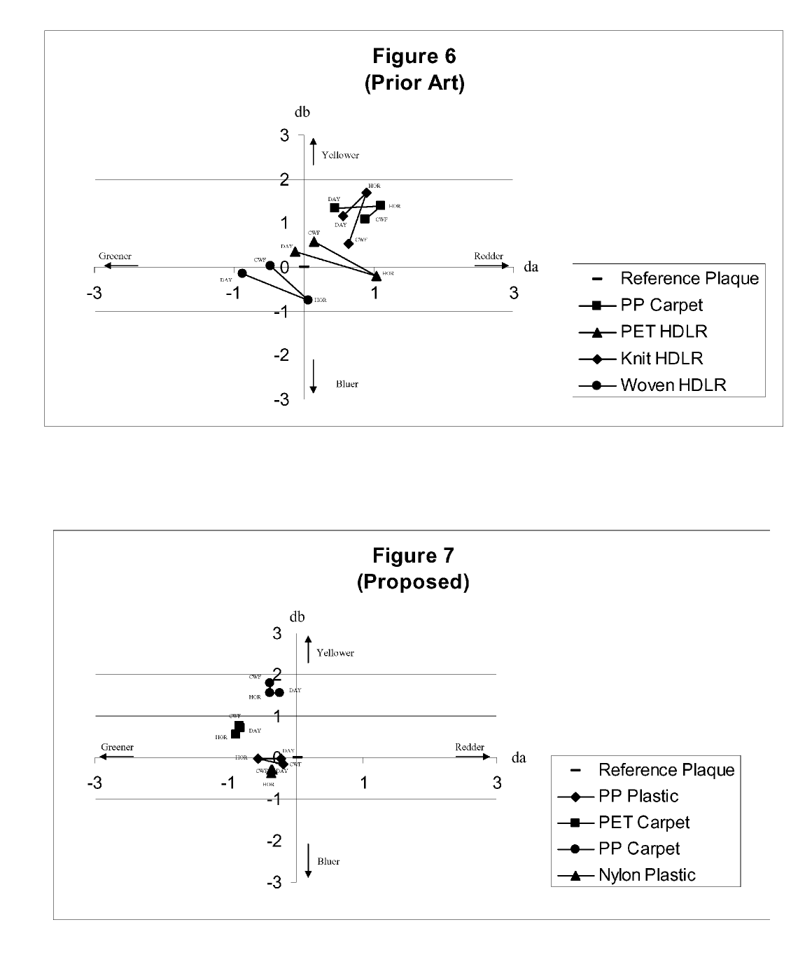

Referring now to FIGS. 6 and 7, there is shown a comparison of the results obtained using the prior art method (FIG. 6) and the method of the current invention (FIG. 7). These CIELAB space plots show the change from the reference plaque of the produced materials in terms of the change in da (red/green) and db (yellow/blue) as a two-dimensional plot to describe visually the flare in the three illuminants, namely, Daylight (D65), Horizon (A), and Cool White Fluorescent (F02). In the plots, Daylight is “DAY”, Horizon is “HOR” and Cool White Fluorescent is “CWF”.

The CIE 1976 L*a*b* color space is the most widely used method for measuring and ordering object color. It is routinely employed throughout the world by those controlling the color of textiles, inks, paints, plastics, paper, printed materials, and other objects. It is sometimes referred to as the CIELAB color difference metric. The CIELAB system is often used to facilitate the quality control of colored products. In these cases, the color of the production sample is located in CIELAB space, and compared to the color standard for production. Color differences between the production sample and standard are computed, and then usually compared to the limits (tolerances) of customer acceptability for the colored product.

The 1976 CIELAB color space is a mathematical transformation of the calorimetric system first published by the CIE in 1931. This transformation is based on the fundamental principles that: (1) color is a sensation resulting from the combination of a light, an object, and an observer, (2) a light source illuminates an object, (3) an object modifies light, and reflects (or transmits) it to an observer, (4) an observer senses the reflected light and (5) tristimulus values are coordinates of color sensation, computed from the CIE (light, object, and observer) data.

The method of describing (and ordering) colors by an opponent-type system follows the idea that somewhere between the eye and the brain, information from cone receptors in the eye gets coded into light-dark, red-green, and yellow blue signals. The concept follows the “opponent” basis that colors cannot be red and green at the same time, or yellow and blue at the same time. However, colors can be considered as combinations of red and yellow, red and blue, green and yellow, and green and blue.

Compared to the Prior Art, the method of the present invention produces products that have much less variation with light source, meaning that the data points are more closely grouped together than with the prior art.

In FIG. 6, the materials manufactured were a polypropylene carpet (PP Carpet), a polyester headliner (PET HDLR), a knit headliner (Knit HDLR), and a woven headliner (Knit HDLR).

In FIG. 7, the materials manufactured were a polypropylene plastic plaque (PP Plastic), a polyester carpet (PET Carpet), a polypropylene carpet (PP Carpet), and a nylon 6 plastic plaque (Nylon Plastic).

In each case, the manufactured products are supposed to be the same color. Relative to the target plaque, the manufactured items of the present invention were closer together per item across various lightings and also closer to each other item-wise and to the target plaque across all lightings. This is readily appreciated when we focus on the PP Carpet in both plots (FIGS. 6 and 7). Under the different lighting conditions, the plotted points are closer together for the PP Carpet produced according to the present invention, than that produced according to the prior art. Further, the plotted points for the PP Carpet made using the present invention are closer to the target plaque color that that of the prior art.

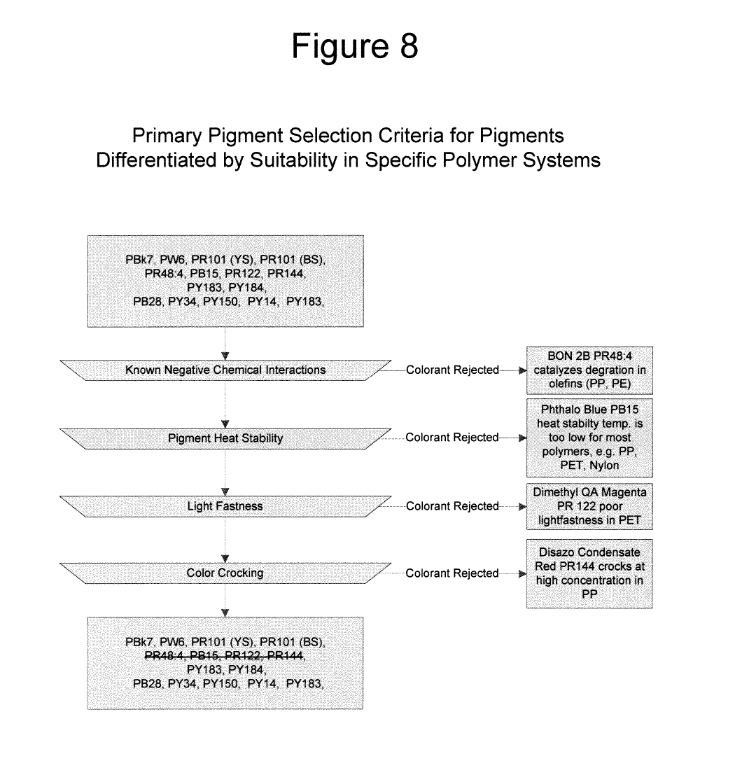

Referring now to FIG. 8, there is depicted in a block chart diagram the effect on a group of pigments to which is applied the primary pigment selection criteria for pigments differentiated by suitability in specific polymer systems (pigment/polymer criteria).

The initial list of pigments to which the criteria is applied are:

PB7, PW6, PR101 (120 nm), PR101 (180 nm), PR48:4, PB15, PR22, PR144, PY183, PY184, PB28, PY34, PY150, PY14, and PY183.

The first criteria is a review of known negative chemical interactions with polymer system, stabilization chemistry, or end-use environment. Chemical interactions with other materials that are typically determined via supplier or public literature or supplier testing. A review is performed for each polymer system of interest. When this group of pigments was screened for known negative chemical interactions, PR48:4 (BON 2B) was rejected since it is known to catalyze degradation in olefins from a review of the supplier's literature. BON 2B, Mn Lake, PR48:4, Color Index #15865:4, CAS#5280-66-0 contains Manganese which may catalyze degradation in polyolefins.

The second criteria is pigment heat stability. The pigment heat stability must be greater than the extrusion temperature used for the polymer system under consideration. Besides typically being made available by the supplier, this information is usually double checked by testing it. Various standard methods are available for determining heat stability. One such standard is DIN EN 12877-1. The heat stability is determined on a white reduction (organic pigments 1:10, inorganic pigments 1:4) in PE-HD in an injection molding machine according to DIN EN 12877-1. The temperature of the melt is increased from 200° C. to 350° C. in steps of 20° C. with a 5-minute dwell time between each step. The heat stability is the highest temperature at which there is no noticeable change in shade (i.e. total color difference DE*>=3.0, measured with CIELab, D65, 10° observer, acc. to DIN 6174).

Cu-Phthalocyanine Alpha instab., PB 15, Color Index #74160, CAS#147-14-8 heat stability is approximately 200 C, which is too low for polyolefin, nylon, or PET extrusion, but may be useful in polyethylene and polyvinyl chloride extrusion.

The third criteria is lightfastness (color fade), which includes checking for polymer degradation. Again, though available from supplier information, this information is typically tested. Pigment lightfast performance must exceed the end-use lightfastness requirement. Examples of standards used in this regard include Colorfastness to Light (AATCC 1 6), SAE J1885: Accelerated Exposure of Automotive Interior Trim Components Using a Controlled Irradiance Water Cooled Xenon-Arc Apparatus. (Perform using each polymer system of interest.) As examples AATCC16: >Step 3 gray scale color change (Gray Scale for Color Change, Evaluation Procedure 1 AATCC) after 200 hrs exposure. SAE J1885: >Step 3 gray scale color change after 639 kJ exposure or customer requirement. No polymer degradation.

PR 122, Dimethyl QA Magenta CI#73195 has good lightfastness in polypropylene and poor fastness in polyester and would not pass SAE J1885>Step 3 gray scale color change limit after 639 kj exposure.

The fourth criteria is color crocking. The AATCC 8-2004 test method is designed to determine the amount of color transferred from the surface of colored textile materials to other surfaces by rubbing. It is applicable to textiles made from all fibers in the form of yarn or fabric whether dyed, printed or otherwise colored. (Perform in each polymer system of interest.) Color transference>step 3 AATCC Evaluation Procedure 8 AATCC 9-Step Chromatic Transference Scale.

Disazo Condensate Red, PR 144 has poor crocking performance and does not meet the minimum acceptable color transference requirement.

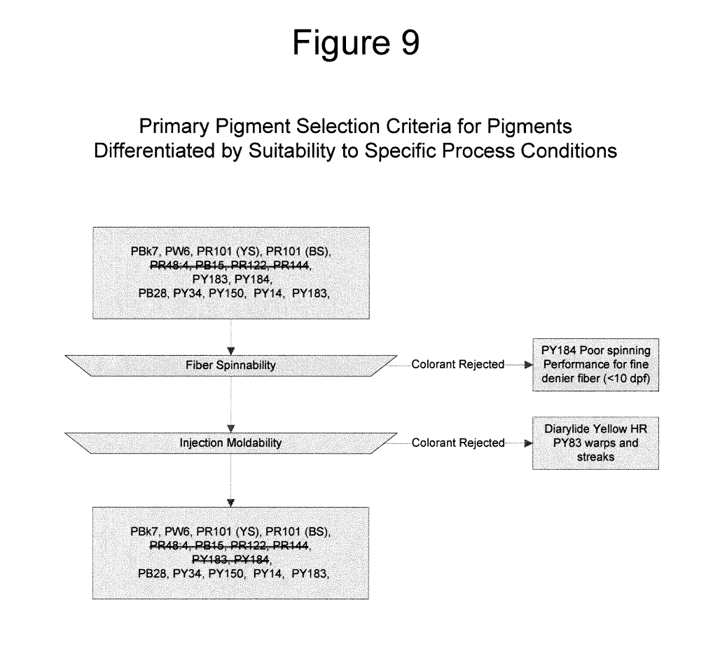

Referring now to FIG. 9, there is depicted in a block chart diagram the effect on a group of pigments to which is applied the primary pigment selection criteria for pigments differentiated by suitability in specific process conditions (pigment/process criteria).

The first criteria in this group is fiber spinnability. This is a direct test to evaluate fiber processing in assorted polymers to determine whether fiber spinning can be achieved at textile fiber denier. Good fiber processing is required at denier ranges required. No excessive filament breaks, able to make yarn package. Able to orient yarn at 22 2:1 draw ratio. Tenacity>2 grams per denier@100% elongation.

Fiber spinnability was determined using the following procedure. The fiber spinnability of a pigment is evaluated by fiber spinning using a Hills Research Compact Spinning line. A polymer sample with a 1% to 5% loading of pigment in pellet form is processed is processed into a 10 denier per filament fiber and is collected on a package or tube. The table below defines the test conditions for fiber spinning. The ability to process the fiber through the spinnerette without breaks in the threadline and during elongation on the rotating godet rolls and subsequent collection on the yarn package is an indicator of the processability of the pigment/polymer system. The fiber is visually evaluated for uniformity of color through the package of yarn. The fiber is further evaluated by stretching to its breaking point to determine the estimate its maximum % elongation and tenacity (grams per denier). Fibers produced having less than 2 grams per denier and less than 100% elongation indicate negative pigment attributes or possible negative interactions with the polymer system.

| | | | |
|---|---|---|---|
| Resin | Polypropylene | Nylon 6 | Polyester |
| Melt Point | 160 C. | 220 C. | 258 C. |
| Viscosity | Melt Index 18 | RV 2.7 | IV .67 |
| Supplier | Pinnacle | BASF | Dupont |
| Code | PP1517 | Ultrmid B3 | 4434 |
| | 10 | 10 | 10 |
| | DPF | DPF | DPF |
| Spinnerette | 349 holes | 349 holes | 349 holes |
| | .038 inch diameter | .038 inch | .038 inch |
| | | diameter | diameter |
| Extruder Temps | C. | C. | C. |
| Zone 1 | 212.8 | 260.0 | 282.2 |
| Zone 2 | 223.9 | 265.6 | 285.0 |
| Zone 3 | 235.0 | 265.6 | 290.6 |
| Zone 4 | 243.3 | 268.3 | 282.2 |
| Spin Head | 243.3 | 271.1 | 276.7 |
| Extruder | 1200 psi | 1200 psi | 1200 psi |
| Pressure | | | |
| Roll Temps | C. | C. | C. |
| Feed Roll | 90.6 | 82.2 | 98.9 |
| Draw Roll | 121.1 | 85.0 | 98.9 |
| Relax Roll | ambient | 37.8 | 71.1 |
| Speed Control | MPM | MPM | MPM |
| Feed Roll | 115 mpm | 161 mpm | 130 mpm |
| Draw Roll | 406 mpm | 393 mpm | 138 mpm |
| Relax Roll | 375 mpm | 373 mpm | 500 mpm |
| Melt Pump | 34.5 rpm | 26.1 rpm | 29.4 rpm |
| Quench Air | as required | as required | as required |
| Spin Finish | as required | as required | as required |
| Spin Finish Type | Ethox AP 296 | Goulston Lurol | Ethox AP 296 |
| | | NF-6004 | |

Using this procedure, Bismuth Vanadate, PY 184, with certain treatments fail in fiber spinning trials.

The second criteria is injection moldability. This is a subjective evaluation of the appearance of extruded part (no warping or shrinkage) and uniformity of color (no streaking or discontinuities). Various methods are available for this test.

D3641-02 Standard Practice for Injection Molding Test Specimens of Thermoplastic Molding and Extrusion Materials: This practice covers the general principles to be followed when injection molding test specimens of thermoplastic molding and extrusion materials. This practice is to be used to obtain uniformity in methods of describing the various steps of the injection molding process and to set up uniform methods of reporting these conditions. The exact conditions required to prepare suitable specimens will vary for each plastic material.

Another method is disclosed as follows. Pigment evaluations for injection moldability are performed using an Arburg 221 M-350/75-25 mm screw diameter injection molding machine. A polymer sample with a 1% to 5% loading of pigment in pellet form is processed into injection molded chips of size 2″×4″. The each chip produced is visually inspected to assess the uniformity of the distribution of the pigment color and to observe visual defects including but not limited to warping, holes, and dimples. Processing is evaluated in each polymer system of potential interest using conditions as summarized below.

| | | | | | Nylon | | |
|---|---|---|---|---|---|---|---|
| Resin | PE | PP | PET | Nylon 6 | 6,6 | TPO | ABS |
| Zone 1 (degrees C.) | 400 | 400 | 520 | 450 | 525 | 400 | 450 |
| Zone 2 (degrees C.) | 400 | 400 | 530 | 500 | 525 | 400 | 450 |
| Zone 3 (degrees C.) | 400 | 400 | 530 | 500 | 550 | 400 | 450 |
| Zone 4 (degrees C.) | 400 | 400 | 530 | 500 | 550 | 400 | 450 |
| Nozzle (degrees C.) | 400 | 400 | 565 | 550 | 585 | 400 | 450 |
| Back Pressure | 2103 | 3365 | 4206 | 2103 | 2103 | 145 | 3785 |
| (PSI) | | | | | | | |
| Screw RPM (ft/ | 95.5 | 95.5 | 95.5 | 95.5 | 95.5 | 65.6 | 95.5 |
| min) | | | | | | | |
| Volume (cubic | 1.75 | 1.46 | 1.71 | 1.7 | 1.81 | 1.95 | 1.68 |
| inches) | | | | | | | |
| Batch Size (grams) | 300 | 300 | 300-500 | 300-500 | 300-500 | 300-500 | 300-500 |

According to the foregoing test method, Diarylide Yellow HR, PY 83, was shown to cause shrinkage, warping and streaks in injection molding sample.

Therefore, after performing the foregoing primary criteria, the following pigments were left satisfying such criteria:

PB7, PW6, PR101 (YS; 120 nm), PR101 (BS; 180 nm), PB28, PY34, PY150, PY14, and PY183 where PR101 (YS) refers to a yellow shade version of PR101 and PR101 (BS) refers to a blue shade version of PR101.

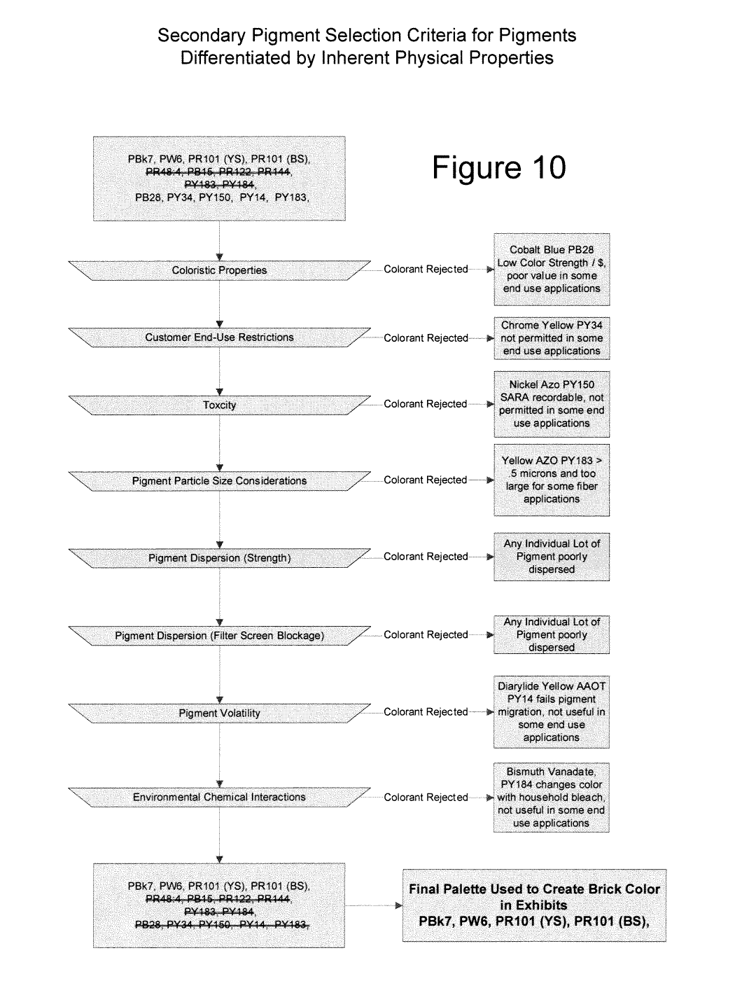

Referring now to FIG. 10, we turn our attention to optional, but preferred, secondary selection criteria for pigments differentiated by their inherent physical properties.

1. Coloristic Properties:

Pigment color space, strength, color properties vs price. Similar coloristic values in polymers. Review supplier information and literature. Standard tests such as DIN EN 13900-2 (Coloristic Properties) can be used.

According to this criteria, Cobalt Blue, PB28, CAS#1345-16-0 is a very weak pigment and must be used at high levels. Might be rejected due to cost per color strength value.

2. Chemical End-Use Restrictions Set by Customer:

Chemistry and/or final quantity in final part must meet customer restriction requirements. See for example, Toyota TSZ0001G, General Motors GMW3059. Other requirement, e.g. FDA approval may apply. This information may be obtained by a review of the supplier's technical information.

TSZ0001G:

Worldwide concern and legislation challenge automakers to reduce or eliminate various Substances of Concern (SOC) from their vehicles. Numerous states and provinces continue to pass new laws focusing on mercury, lead, hexavalent chrome and cadmium. Toward this, Toyota has established a global technical standard, designated TSZ0001G, which governs SOC management and usage in our products. Members of Toyota's North American affiliates collaborate through the SOC Task Force to implement our SOC education and elimination plan.

GMW3059:

This specification lists substances whose use in materials and components, in the interests of personnel and environmental safety, are either prohibited or limited. These restrictions are based on existing legislation or self-imposed regulations. The aim of this specification is to restrict/stop the usage of the substances listed, to facilitate compliance with current and future regulations.

Chrome Yellow, PY34, Color Index #77603, CAS#1344-37-2, Contains Lead, Chromium not allowed in GM3059P, TSZ0001G.

3. Pigment Toxicity Considerations:

Chemistry must be compatible with customer's requirements and acceptable for safe processing and disposal. Review Pigment Supplier Technical Bulletin, MSDS, FDA approved materials list, SARA.

Nickel Azo Yellow, PY150, listed as a SARA recordable material. Considered a skin irrantant. IARC states there is sufficient evidence of carcinogenicity in experimental animals and humans.

4. Pigment Particle Size:

Median particle size<5% of typical fiber diameter. For plastics, particles size that permits uniform coloration. Review Pigment Supplier Technical Bulletin and measure using standard methods, for example, ASTM D1366-86 (2003). This practice for reporting the fineness characteristics of pigments is designed to apply in most cases where well-known methods for determining these particle size characteristics in the subsieve range are employed, such as microscopic, sedimentation, and turbidimetric methods; and partially to absorption and permeability methods.

PY183, Color Index 18792, CAS#65212-77-3 has a particle size of 1.3 microns and could not be used in a fiber below a 6 dpf.

5. Pigment Dispersibility Related to Color Strength:

Review Pigment Supplier Technical Bulletin and measure ease of dispersion. Dispersion measured by lot and evaluated based on expected results for various pigment/resin systems. An example of various standards for this purpose is DIN EN 13900-2 (Ease of Dispersion). The dispersibility is tested in PVCP (some pigments in PE) by a method based on DIN EN 13900-2. The pigment is dispersed at 160° C. on a two-roll mill. Part of the sheeted-out compound is then separated off and cooled to room temperature, after which it subjected to further dispersion at 130° C. The dispersibility is calculated from the relative increase in color strength between the two stages of dispersion. Note: the lower the value, the easier the pigment is to disperse.

Any particular pigment lot might fail for dispersion, if improperly dispersed in a carrier resin. Therefore, each lot is evaluated for dispersion quality.

6. Pigment Dispersion Related to Filter Screen Blockage.

Review Pigment Supplier Technical Bulletin, pressure rise testing, and filter pressure value. delta P<400 psi, FPV<3. Example standards include ASTM 3218, DIN EN 13900-5.

ASTM 3218:

This specification covers polyolefin monofilament yarn materials, and test methods for standard polyolefin monofilaments. While designed primarily for testing standard polyolefin monofilaments, many of the procedures can be used, with little or no modification, for other polyolefin monofilaments. It includes procedure for filter pressure testing of polymer melts.

DIN EN 13900-5:

The test mixture is processed in a single screw extruder with a non-grooved barrel and a compression screw with additional mixing elements. The polymer melt is fed with a constant pressure of 30 to 60 bar (435 to 870 psi) to the Melt Pump with a volume of 1.2 cm³/rpm. With this metering pump a constant volume of 50 to 60 cm³/min (setting 660 on the HAAKE Melt pump) polymer passes the filter package. Particles and agglomerates over a certain size are retained and clog the filter package. A pressure increase is observed and is correlated with the quality of the colorant. The pressure difference between the initial pressure and the peak pressure is used for the calculation of FPV—filter pressure value.

Any particular pigment lot might fail for dispersion, if improperly dispersed in a carrier resin. Each lot is evaluated for dispersion quality.

7. Pigment Volatility:

Review Pigment Supplier Technical Bulletin. An example of a standard used for this purpose is DIN 53775-3. Fastness>Step 3 on gray scale.

The fastness to migration is tested on a colored specimen in contact with a white, pigmented PVC film according to DIN 53775, part 3. Pigment concentrations in the test specimen Organic pigments: mass tone=0.20% pigment white reduction=0.10% pigment and 1% TiO2 Inorganic pigments: mass tone=2% pigment white reduction=0.25% pigment and 1% TiO2 Other concentrations may result in different fastness ratings. The migration fastness is assessed on the grey scale described in DIN EN 20105-A3. Migration fastness 5=no bleeding, 1=very strong bleeding.

DIARYLIDE YELLOW AAOT, PY 14 fails for migration in some cases.

8. Environmental Chemical Interactions:

Determined on case-by-case basis or by end-use requirement.

REVIEW SUPPLIER TECHNICAL INFORMATION, Colorfastness to Water, Colorfastness to Bleach, Colorfastness to Burnt Gas Fumes. Various exposure methods to simulate end-use exposure to various environments and to determine colorfastness in those environments are available. See, AATCC 107 (Water), TM 188 (Sodium Hypochlorite Bleach) AATCC 23 (Burnt Gas Fumes).

Bismuth Vanadate, PY184 changes color when exposed to certain cleaning materials and sodium hypochlorite.

After evaluating the pigments that met the primary criteria, the following pigments also satisfied the secondary criteria:

PB7, PW6, PR101 (120 nm), and PR101 (180 nm).

These were the pigments use to generate a pigment library and then a colorant (palate) database. These were in turn used to generate the Brick color exhibits in FIGS. 2 and 3.

Although a preferred embodiment of the invention has been shown and described, it should be understood that various modifications and substitutions, as well as rearrangements and combinations, can be made by those skilled in the art, without departing from the spirit and scope of this invention.

What is claimed is:

1. Method for preparing a pigment library, the method comprising
identifying a plurality of thermoplastic polymers and
selecting pigments useful in the plurality of thermoplastic polymers,
wherein each of the pigments possesses the property of being:
heat stable at the melt temperature of each of the polymers of the plurality of thermoplastic polymers and
not chemically interactive or reactive with each of the polymers of the plurality of thermoplastic polymer, and
wherein each of the pigments in combination with each of the polymers of the plurality of thermoplastic polymers possesses the property of:
being lightfast,
not crocking,
being injection moldable, and
being fiber spinnable.

2. A pigment library, comprising a plurality of pigments, where in each of the pigments of said plurality of pigments is selected from the group of organic and inorganic pigments,
such that each pigment of the plurality of pigments is at least
heat stable in each of the polymers of said plurality of thermoplastic polymers and not chemically interactive or reactive with any polymer of the plurality of thermoplastic polymers, and
such that each pigment of the plurality of pigments in combination with each of the polymers of the plurality of thermoplastic polymers is at least
lightfast, injection moldable and fiber spinnable and at least does not crock.

3. A method of preparing a primary colorant database, said method comprising:
using a plurality of pigments compatible with a plurality of polymers, where in the plurality of pigments is a pigment library according to claim 2;
preparing a plurality of mixtures of each pigment of the pigment library and a virgin polymer of each of the polymers of the plurality of polymers at a plurality of pigment concentration desired;
preparing plurality of exhibits, wherein each exhibit of the plurality of exhibits corresponds in form to an end product and uses a single pigment at a single concentration in a single virgin polymer;
measuring the reflectance information for each exhibit of the plurality of exhibits using a spectrophotometer;
storing the reflectance information for each exhibit of the plurality of exhibits.

4. The method of claim 4, wherein each of the exhibits of the plurality of exhibits is the same as or different from the other exhibits of the plurality of exhibits and is selected from the group consisting of card wrapped yarn, non-woven fabric, POM sets, knitted socks, plastic plaque smooth surface, plastic plaque textured surfaces, and plastic films.

5. A primary colorant database made according to the method of claim 3.

6. Method for color matching a target sample having target spectral characteristics to a plurality of end products in various forms using a plurality of polymers, said method comprising:
(a) measuring the target spectral characteristics of the target sample using a spectrophotometer and generate target spectral data;
(b) for each combination of end product form and corresponding one of the plurality of polymers,
(1) predicting a sample formulation using the pigment library of claim 2 and the reflectance data of the corresponding to the combination from the primary colorant database of claim 4, wherein the sample formulation has a predicted spectral data,
(2) comparing the predicted spectral data of the sample formulation to the target spectral data to determine if there is a match,
(3) if there is not a match in step (b)(2), then adjusting the sample formulation until the resulting adjusted sample spectral data matches the target spectral data,
(4) if there is a match in step (b)(2), then making a trial sample using the sample formulation with the corresponding one of the plurality of polymers in the corresponding end product form,
(5) determining if there is an acceptable match between the trial sample and the target sample has been achieved as observed under a plurality of lighting conditions,
(6) if there is not acceptable match in step (b)(5), then measuring the trial spectral characteristics of the trial sample using a spectrophotometer and generating trial spectral data,
(7) then reformulating the sample formulation based on the differences between the trial spectral data and the target spectral data,
(8) repeating steps (b)(2) through (b)(7) until an acceptable match is achieved, and
(9) if an acceptable match is achieved in step (b)(5), then making an exhibit using the sample formulation in the respective end product form;
(c) assembling all of the exhibits together, wherein each of the exhibits has a corresponding one of the plurality of polymers which is in one of the end product forms;
(d) evaluating all of the exhibits using multiple illuminants to verify non-metameric acceptability;
(e) if there is non-metameric acceptability, then approving the sample formulations for use to produce the end products; and
(f) if there is no non-metameric acceptability,
(1) then measuring the spectral characteristics of the non-acceptable exhibits using a spectrophotometer and generating exhibit spectral data for the non-acceptable exhibits,
(2) then reformulating the sample formulation based on the differences between the exhibit spectral data and the target spectral data, and
(3) then repeating starting at step (b)(2) through step (d) for the end product form and polymer corresponding to the non-acceptable exhibits until non-metameric acceptability is achieved for all exhibits.

7. The method of claim 6, wherein the steps for predicting, adjusting and reformulating the sample formulation use a formulation software program that utilizes the primary colorant database.

8. The method of claim 6, wherein the step of determining if there is an acceptable match between the trial sample and the target sample has been achieved as observed under a plurality of lighting conditions uses the standard lighting conditions according to SAE J361 (Procedure for Visual Evaluation of Interior and Exterior Automotive Trim), wherein the multiple illuminants are provided by a fixture providing daylight, fluorescent, and horizon lighting conditions.

9. The method of claim 6, said method further comprising:
providing a network having a user interface;
receiving through said user interface the target spectral data and target non spectral data comprising end product form, end product texture, and polymer type; and
displaying the sample formulation on the network as predicted, adjusted and reformulated.

10. The method of claim 9, further comprising:
receiving through said user interface quantity information;
implementing software capable of determining a price quote by utilizing said quantity information and said sample formulation;
determining said price quote by utilizing said quantity information and said sample formulation; and
displaying on the network said price quote.

11. A system for matching a target sample having spectral characteristics, the system comprising:
(a) a first computer at a first location operative to receive and to transmit target spectral data and target non-spectral data;
(b) a second computer at a second location remote from the first location, the second computer being operative to receive the target spectral data and the target non-spectral data from the first computer;
(c) a database including a primary colorant database according to claim 4; and
(d) software residing on the first computer and capable of using the target spectral data and the database to generate a sample formulation having a predicted sample spectral data that matches the target spectral data, wherein the sample formulation also takes into account the target non-spectral data comprising end product form, end product texture, and polymer type.

12. A system as defined in claim 11, wherein said database resides on said second computer.

13. A system as defined in claim 11, wherein said database resides on said first computer.

14. A system as defined in claim 11, further comprising a device operative to sense said target spectral data from a target sample and to input said target spectral data into said first computer.

15. A system as defined in claim 14, wherein said device is a spectrophotometer.

16. A system as defined in claim 11, wherein said software is further capable of providing a price quote for a product made in accordance with the matching sample formulation.
